(19) United States
(12) Patent Application Publication
(10) Pub. No.: US 2022/0413461 A1
(43) Pub. Date: Dec. 29, 2022

(54) Machining-Control-Information Generation Device, Machining-Control-Information Generation Method, And Program

(71) Applicant: ThinkR Inc., Kyoto (JP)

(72) Inventor: Yuki Yamamoto, Kyoto (JP)

(73) Assignee: Hilltop Corporation, Kyoto (JP)

(21) Appl. No.: 17/620,578

(22) PCT Filed: Apr. 23, 2021
(86) PCT No.: PCT/JP2021/016547

§ 371 Date: Dec. 17, 2021

(51) Int. Cl. G05B 19/18

(52) U.S. Cl. CPC G05B 19/182; G05B 2219/35527

(57) ABSTRACT

A machining-control-information generation device includes a feature extractor that extracts a feature indicating a shape feature of a product based on product information, a machining-method specifier that specifies a machining method, using a machining-method specifying model, a feature specifier that specifies an optimal feature, using a feature specifying model, a machining-order specifier that specifies a machining order when all of machining target portions corresponding to optimal feature information are machined, using a machining-order specifying model, and a machining-control-information generator that selects a machining condition corresponding to the optimal feature information indicating the specified machining method and the specified optimal feature, and generates machining control information based on machining order information, machining condition information, the optimal feature information, and partial machining method information.

### FIELD OF THE INVENTION

The present disclosure relates to a machining-control-information generation device, a machining-control-information generation method, and a program.

### BACKGROUND OF THE INVENTION

There has been proposed a machining data consistent generation device (see, for example, Patent Literature 1). The machining data consistent generation device recognizes shape features to be machined from machined shape data, extracts individual shape features as normal-position features, then generates, from the extracted normal-position features, dependent features indicating shape features each in at least one machining coordinate system corresponding to a machining device to be used, determines a tool to be used and a cutting condition for each of the generated dependent features, calculates, for all of the dependent features, the machining efficiency when machining is performed according to the determined cutting condition using the determined tool, then determines the dependent feature with the highest calculated machining efficiency as an optimal dependent feature, and generates integrated machining data based on the optimal dependent feature.

### PATENT LITERATURE

Patent Literature 1: Unexamined Japanese Patent Application Publication No. 2014-075000.

### SUMMARY OF THE INVENTION

### Technical Problem

However, with the machining data consistent generation device disclosed in Patent Literature 1, if a plurality of types of normal-position features is extracted for one machining target portion, many dependent features are generated accordingly. In this case, the necessary calculation amount until the integrated machining data is output increases, and the time from the input of the machined shape data to the output of the integrated machining data can be prolonged.

The present disclosure has been made in view of the above circumstances, and an objective of the present disclosure is to provide a machining-control-information generation device, a machining-control-information generation method, and a program that are capable of shorten the time for generating machining control information from product information.

### Solution to Problem

In order to achieve the above objective, a machining-control-information generation device according to the present disclosure is a machining-control-information generation device that generates machining control information for a machine tool to cut out a product by the machine tool from a workpiece, the machining-control-information generation device including:

a product-information acquirer that acquires product information indicating a finished shape and finished dimensions of the product;

a workpiece-information acquirer that acquires workpiece information indicating a shape, dimensions, and a material of the workpiece;

a feature extractor that extracts a feature indicating a shape feature of the product based on the product information;

a machining-method specifier that specifies, from feature information indicating the feature, a machining method, using a machining-method specifying model for specifying the machining method of cutting corresponding to each piece of the feature information;

a feature specifier that specifies, from the feature information and partial machining method information indicating the machining method specified by the machining-method specifier, an optimal feature, using a feature specifying model for specifying a feature optimal for machining the product;

a machining-order specifier that specifies, from optimal feature information indicating the optimal feature and the partial machining method information, a machining order when all of machining target portions corresponding to the optimal feature information are machined, using a machining-order specifying model for specifying the machining order when all of the machining target portions corresponding to the optimal feature information are machined; and

a machining-control-information generator that selects, from among preset machining conditions including a type of a tool to be used and a machining path of the tool, a machining condition corresponding to the machining method and the optimal feature information based on the partial machining method information and the optimal feature information indicating the optimal feature, and generates the machining control information based on machining order information indicating the machining order, machining condition information indicating the machining condition, the optimal feature information, and the partial machining method information.

### Advantageous Effects of Invention

According to the present disclosure, a feature specifier specifies, from feature information and partial machining method information indicating a machining method specified by a machining-method specifier, an optimal feature, using a feature specifying model for specifying a feature optimal for machining a product. As a result, even if a plurality of types of features for one machining target portion is extracted by a feature extractor, it is possible for the feature specifier to narrow down the features to be used to generate machining control information only to the optimal feature. Accordingly, it is possible to reduce the number of the features to be used to generate the machining control information, and thus to shorten the time for generating the machining control information from product information.

### BRIEF DESCRIPTION OF THE DRAWINGS

FIG. 1 is a schematic configuration diagram of a machining-control-information generation system according to an embodiment of the present disclosure;

FIG. 2 is a block diagram illustrating a hardware configuration of a machining-control-information generation device according to the embodiment;

FIG. 3 is a block diagram illustrating a functional configuration of the machining-control-information generation device according to the embodiment;

FIG. 4 is a diagram illustrating an example of information stored in a machining-method storage according to the embodiment;

FIG. 5 is a diagram illustrating examples of a machining-method specifying model, a feature specifying model, or a machining-order specifying model according to the embodiment;

FIG. 6 is a flowchart illustrating an example of a procedure of a machining-control-information generation process performed by the machining-control-information generation device according to the embodiment;

FIG. 7 is a flowchart illustrating an example of a procedure of a model update process performed by the machining-control-information generation device according to the embodiment; and

FIG. 8 is a flowchart illustrating an example of the procedure of a machining-control-information generation process performed by the machining-control-information generation device according to the embodiment.

### DETAILED DESCRIPTION OF THE INVENTION

Hereinafter, a machining-control-information generation device according to an embodiment of the present disclosure will be described with reference to the drawings. The machining-control-information generation device according to the present embodiment generates machining control information for a machine tool to cut out a product by the machine tool from a workpiece. This machining-control-information generation device includes a feature extractor that extracts a feature indicating a shape feature of the product based on product information indicating a finished shape and finished dimensions of the product, a machining-method specifier that specifies, from feature information indicating the feature, a machining method, using a machining-method specifying model for specifying the machining method of cutting each corresponding to each piece of the feature information, and a feature specifier that specifies, from the feature information and partial machining method information indicating the machining method specified by the machining-method specifier, an optimal feature, using a feature specifying model for specifying a feature optimal for machining of the product. This machining-control-information generation device further includes a machining-order specifier that specifies, from optimal feature information indicating the optimal feature and the partial machining method information, a machining order when all of machining target portions corresponding to the optimal feature information are machined, using a machining-order specifying model for specifying the machining order when all of the machining target portions corresponding to the optimal feature information are machined, and a machining-control-information generator that selects, from among preset machining conditions including a type of a tool to be used and a machining path of the tool, a machining condition corresponding to the machining method and the optimal feature information based on the partial machining method information and the optimal feature information indicating the optimal feature, and generates the machining control information based on machining order information indicating the machining order, machining condition information indicating the machining condition, the optimal feature information, and the partial machining method information.

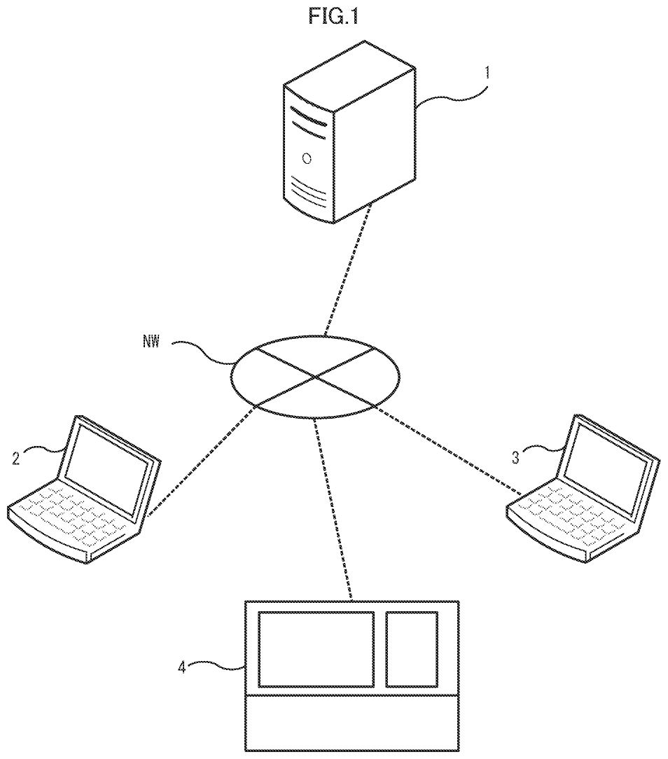

As illustrated in, for example, FIG. 1, a machining-control-information generation device 1 according to the present embodiment is communicable among a terminal device 2 of a user of a machine tool 4, a terminal device 3 of an administrator of the machining-control-information generation device 1, and the machine tool 4 via a network NW. The administrator of the machining-control-information generation device 1 is, for example, a company that provides machining control information for manufacturing a product to the user of the machine tool 4. The terminal device 2 is a personal computer, a smartphone, or the like, and when the user inputs product information indicating a finished shape and finished dimensions of a product to be manufactured by the machine tool 4 via an input while an operation screen for inputting the product information is displayed on a display, the terminal device 2 transmits the input product information to the machining-control-information generation device 1 via the network NW. Here, the display is a display device, such as a liquid crystal display or an organic electro-luminescence (EL) display, and the input is an input device, such as a keyboard or a transparent touch pad disposed to overlap the display. In addition, the product information includes drawing information about the product in, for example, an initial graphics exchange specification (IGES) format or a standard for the exchange of product model data (STEP) format, and information indicating a material of the product.

Similarly to the terminal device 2, the terminal device 3 is a personal computer, a smartphone, or the like, acquires partial machining method information, feature information, and machining order information, which will be described later, transmitted from the machining-control-information generation device 1 via the network NW, and displays the acquired partial machining method information, the acquired feature information, and the acquired machining order information on the display. In addition, when the administrator operates the input to modify a machining method, a feature, and a machining order that are to be selected while referring to the partial machining method information, feature information, and machining order information displayed on the display, the terminal device 3 generates modification instruction information including the modified partial machining method information, the feature information, and the machining order information based on the input operation content. Then, the terminal device 3 transmits the generated modification instruction information to the machining-control-information generation device 1 via the network NW.

The machine tool 4 monitors a load applied to a tool during machining of a workpiece, and transmits load information indicating a history of the load applied to the tool during machining to the machining-control-information generation device 1 via the network NW each time machining of the workpiece based on one piece of machining control information is completed. Here, the load information includes load measurement information obtained by measuring a load applied to the tool, feature information extracted based on the product information about the product to be machined by the machine tool 4, and optimal feature information, which will be described later, corresponding to a machining target portion of the machine tool 4.

The machining-control-information generation device 1 is, for example, a computer for a server, and includes a central processing unit (CPU) 101, a main storage 102, an auxiliary storage 103, a communicator 106, and a bus 109 connecting the respective components. The CPU 101 is, for example, a multi-core processor. The main storage 102 is a volatile memory such as a random access memory (RAM), and is used as a work area of the CPU 101. The auxiliary storage 103 includes a non-volatile memory such as a read only memory (ROM) and a storage unit, and stores a program for implementing various functions of the machining-control-information generation device 1. The communicator 106 communicates with the terminal device 2 and the machine tool 4 via the network NW.

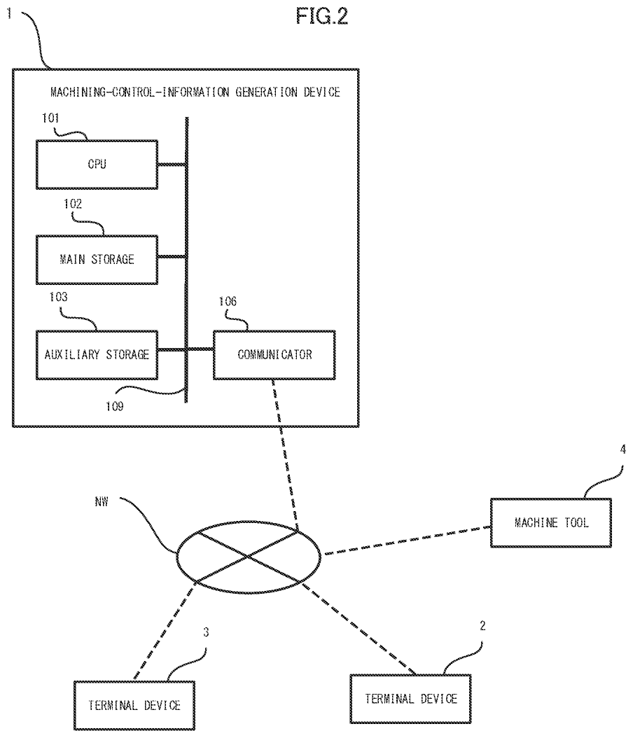

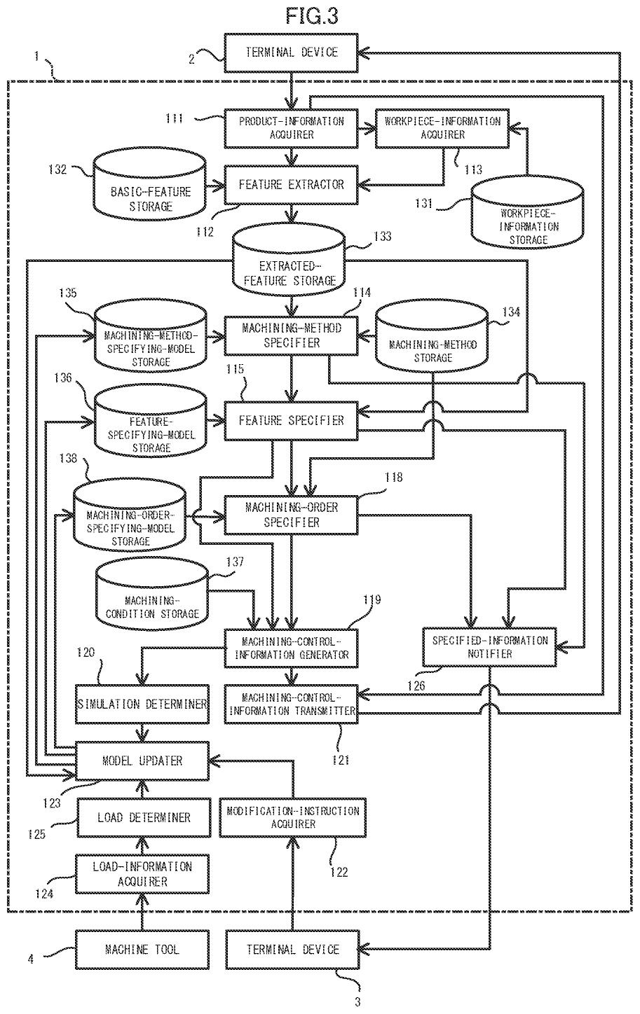

The CPU 101 loads the program stored in the auxiliary storage 103 into the main storage 102 and executes the program to function as a product-information acquirer 111, a feature extractor 112, a workpiece-information acquirer 113, a machining-method specifier 114, a feature specifier 115, a machining-order specifier 118, a machining-control-information generator 119, a simulation determiner 120, a machining-control-information transmitter 121, a modification-instruction acquirer 122, a model updater 123, a load-information acquirer 124, a load determiner 125, and a specified-information notifier 126, as illustrated in FIG. 3. As illustrated in FIG. 3, the auxiliary storage 103 illustrated in FIG. 2 includes a workpiece-information storage 131, a basic-feature storage 132, an extracted-feature storage 133, a machining-method storage 134, a machining-method specifying model storage 135, a feature-specifying-model storage 136, a machining-condition storage 137, and a machining-order specifying model storage 138.

The workpiece-information storage 131 stores workpiece information indicating preset shapes, preset dimensions, and preset materials of a plurality of types of workpieces in association with workpiece identification information for identifying the workpieces. Here, as the information indicating the shapes and the dimensions of the workpieces, information indicating dimensional specifications is used when, for example, the workpiece is a block material. As the information indicating the material, information indicating a material name or a material code is used, for example. In addition, the workpiece information may include identification information about machine tools that can be used for cutting the workpieces. The workpiece information is only required to be stored in the workpiece-information storage 131 in advance by, for example, a user who administers the machining-control-information generation device 1 via a terminal device (not illustrated) that can communicate with the machining-control-information generation device 1.

The basic-feature storage 132 stores basic feature information indicating a plurality of types of preset basic features in association with feature type information indicating the types of features. Here, a basic feature indicates a shape feature of a product and is constituted by at least one surface. The extracted-feature storage 133 stores feature information indicating a feature extracted by the feature extractor 112 and specification information generated by the feature extractor 112 in association with each other.

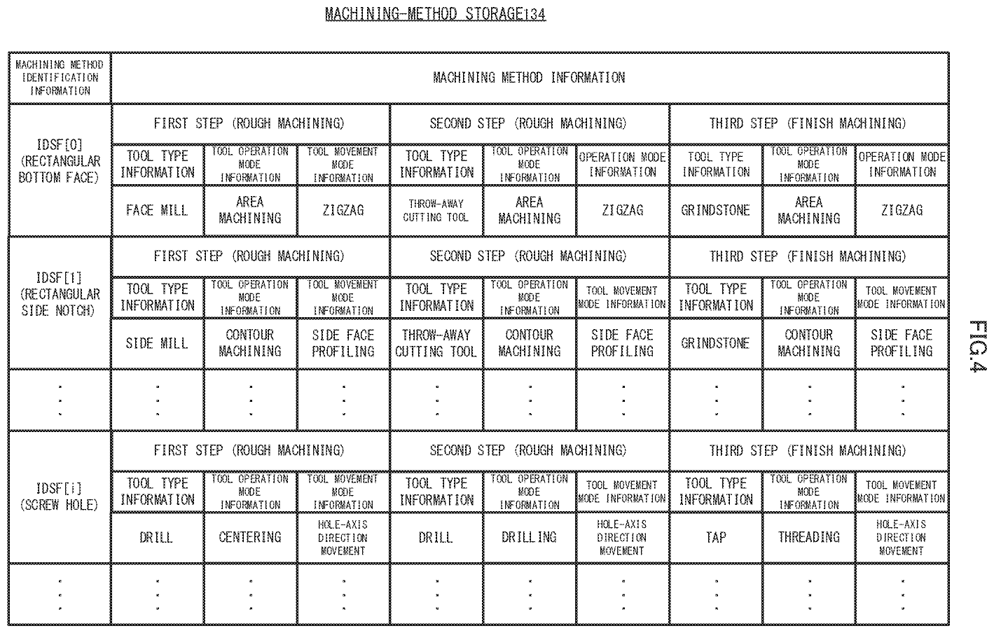

The machining-method storage 134 stores partial machining method information indicating a machining method for each of a plurality of types of features in association with machining method identification information. Here, as illustrated in, for example, FIG. 4, the partial machining method information includes, for each step required for machining a workpiece, tool type information indicating the type of a tool to be used, operation mode information indicating the operation mode of the tool, and tool movement mode information indicating the movement method of the tool. The partial machining method information indicates that the machining is performed in the order of a first step, a second step, and a third step. The example illustrated in FIG. 4 shows, regarding the feature of a “screw hole”, that centering is performed using a drill in the first step, that drilling is next performed using the drill in the second step, and that threading is finally performed using a tap in the third step. The machining method identification information is allocated as a machining method identification number.

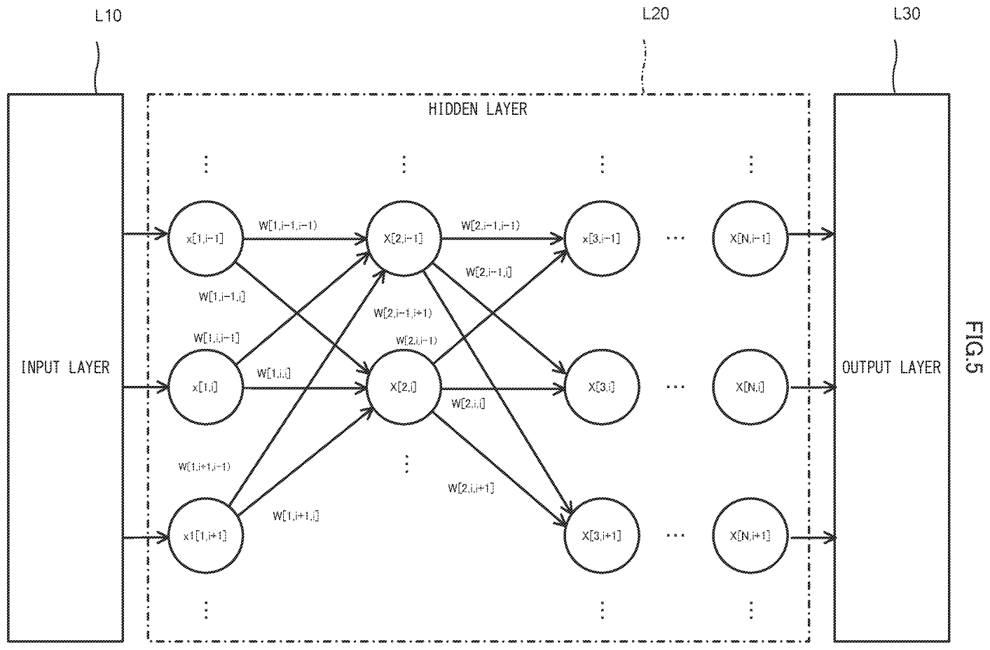

The machining-method specifying model storage 135 stores information indicating a machining-method specifying model for specifying the machining method identification information from the feature information and the specification information. The machining-method specifying model is a feedforward neural network having an input layer L10, a hidden layer L20, and an output layer L30 as illustrated in FIG. 5, for example. Here, numerical information indicating the numerical value indicating the type, the position, the dimension, and the like of each feature extracted by the feature extractor 112 is input to the input layer L10. The hidden layer L20 is constituted by N (N is a positive integer) layers including a preset number M[j] of nodes x[j, i] (1≤i≤M[j], M[j] is a positive integer). That is, the hidden layer L20 has a structure in which the node rows are connected to each other. Here, the output y[j, i] of each node x[j, i] is expressed by the following relational expression (1).

$$\begin{matrix}[ Expression 1 ] & \\ y [ j , k ] = f ( {\sum }_{i = 1}^{M ( j - 1 )} W [ j - 1 , i , k ] \times y [ j - 1 , i ] ) & Expression ( 1 )\end{matrix}$$

wherein W[j, i, k] represents a weighting factor, and f(*) represents an activation function. The weighting factor W[j, i, k] corresponds to a neural network factor that determines the structure of the above neural network. In addition, as the activation function, a nonlinear function such as a sigmoid function, a ramp function, a step function, or a softmax function is used. In the hidden layer L20, the information input to a node is the sum obtained by multiplying the output of each node in the previous layer by the weighting factor. Then, the output of the activation function with the sum as an argument is transmitted to the next layer. The output layer L30 converts the output y[j, i] from the last layer of the hidden layer L20 into a Q-value vector having a value (hereinafter, referred to as a “Q value”) corresponding to each of a plurality of types of preset machining methods as an element, and outputs the Q-value vector. The output layer L30 calculates the Q value corresponding to each of the plurality of types of machining methods using, for example, a softmax function.

When the machining-method specifying model is a neural network as illustrated in FIG. 5, the machining-method specifying model storage 135 stores information indicating a structure of the neural network and information indicating a weighting factor for the neural network. Here, the information indicating the structure of the neural network includes information indicating the number of nodes, the number of layers, and an activation function corresponding to each node of the neural network, and the information indicating the weighting factor is information indicating a weighting factor W[j, i, k] corresponding to each node of the neural network.

Returning to FIG. 3, the feature-specifying-model storage 136 stores information indicating a feature specifying model for specifying an optimal feature from the feature information, the machining method identification number of the machining method specified by the machining-method specifier 114, and the specification information. Similarly to the machining-method specifying model, the feature specifying model is a neural network having an input layer L10, a hidden layer L20, and an output layer L30 as illustrated in FIG. 5, for example. In this case, the output layer L30 converts the output y[j, i] from the final layer of the hidden layer L20 into a Q-value vector having an element that is a Q value corresponding to each extracted feature.

The machining-condition storage 137 stores machining condition information indicating the dimension, the possible operation speed, the possible operation, and the movable range of each of a plurality of types of tools in association with tool identification information for identifying the tools. In addition, the machining-condition storage 137 stores, for each of the plurality of types of tools, stiffness information indicating a correlation between the operation speed of the tool, the moving direction of the tool, and the stiffness of the tool.

The machining-order specifying model storage 138 stores information indicating a machining-order specifying model for specifying a machining order from the feature information and the machining method identification information. Similarly to the machining-method specifying model and the feature specifying model, the machining-order specifying model is a neural network having an input layer L10, a hidden layer L20, and an output layer L30 as illustrated in FIG. 5, for example. In this case, the output layer L30 converts the output y[j, i] from the last layer of the hidden layer L20 into a Q-value vector having a Q value corresponding to each of a plurality of types of preset machining orders as an element, and outputs the Q-value vector.

The product-information acquirer 111 acquires product information transmitted from the terminal device 2 and indicating the finished shape and the finished dimensions of the product cut out from a workpiece by the machine tool 4. The product-information acquirer 111 notifies the feature extractor 112 and the workpiece-information acquirer 113 of the acquired workpiece information. In addition, the product-information acquirer 111 notifies the machining-control-information transmitter 121 of terminal identification information for identifying the terminal device 2 that is the transmission source of the product information. Here, the terminal identification information includes, for example, address information allocated to the terminal device 2.

The workpiece-information acquirer 113 acquires the workpiece information indicating the shape, the dimensions, and the material of the workpieces from the workpiece-information storage 131. Based on the product information, the workpiece-information acquirer 113 searches for and acquires workpiece information about a workpiece having the same material as the material of the product and having a shape and dimensions including the product. Then, the workpiece-information acquirer 113 notifies the feature extractor 112 of the acquired workpiece information.

The feature extractor 112 extracts a feature indicating a shape feature of the product based on the product information. The feature extractor 112 refers to the basic feature information stored in the basic-feature storage 132, searches for a portion matching the basic feature from among product shapes indicated by the product information, and specifies the type, the dimensions, and the position of the feature included in the product. Then, the feature extractor 112 causes the extracted-feature storage 133 to store feature information indicating the extracted feature. In addition, the feature extractor 112 generates specification information corresponding to each feature from the feature information indicating each extracted feature, the product information notified from the product-information acquirer 111, and the workpiece information notified from the workpiece-information acquirer 113. The specification information includes, for example, setup state information regarding setting of a tool before machining, and machining area information indicating an area to be machined. The setup state information includes, for example, material identification information for identifying a material, information indicating a reference position and a reference axis direction when the tool is set, information indicating the number of machining areas, and the like. In addition, the machining area information includes, for example, at least one piece of feature identification information for identifying a reference position and dimensions of a machining area, a reference axis of a machining coordinate system, a state of a machined surface, a machining allowance amount, or a feature. The feature extractor 112 causes the extracted-feature storage 133 to store the generated specification information in association with the feature information.

The machining-method specifier 114 specifies, from each piece of the feature information and the specification information stored in the extracted-feature storage 133, a machining method corresponding to each feature, using the above machining-method specifying model. Specifically, the machining-method specifier 114 calculates, from each piece of the feature information and the specification information, a Q-value vector having a Q-value corresponding to each of the plurality of types of preset machining methods as an element, using the above machining-method specifying model. Then, the machining-method specifier 114 specifies machining method identification information for identifying a machining method corresponding to the highest Q value among the elements of the calculated Q-value vectors. Then, the machining-method specifier 114 notifies the feature specifier 115 of the specified machining method identification information. In addition, the machining-method specifier 114 acquires partial machining method information corresponding to the specified machining method identification information from the machining-method storage 134, and notifies the specified-information notifier 126 of the acquired partial machining method information.

The feature specifier 115 specifies, from the feature information and the specification information stored in the extracted-feature storage 188 and the machining method identification information notified from the machining-method specifier 114, an optimal feature to be used to machine the product, using the above feature specifying model. Specifically, the feature specifier 115 calculates, from the feature information, the specification information, and the machining method identification information, a Q-value vector having a Q-value corresponding to each extracted feature as an element, using the above feature specifying model. Then, the feature specifier 115 specifies a feature corresponding to the highest value among the elements of the calculated Q value vectors as an optimal feature. Then, the feature specifier 115 notifies the machining-control-information generator 119 of the optimal feature information indicating the specified optimal feature and the machining method identification information corresponding thereto. In addition, the feature specifier 115 notifies the specified-information notifier 126 of the specified feature information.

The machining-order specifier 118 specifies, from the feature information and the machining method identification information, a machining order when all of machining target portions corresponding to each piece of the feature information, using the above machining-order specifying model. Specifically, the machining-order specifier 118 calculates, from the machining condition information, the feature information, and the machining method identification information, a value corresponding to each of the plurality of types of preset machining orders, using the above machining-order specifying model. Then, the machining-order specifier 118 specifies a machining order corresponding to the highest Q value among the elements of the calculated Q value vectors. In addition, when a machining target portion corresponding to each feature is machined according to the specified machining order, the machining-order specifier 118 sets a retraction path and an approach path of the tool from retraction from the machining target portion machined earlier to arrival at the machining target portion to be machined next. The machining-order specifier 118 notifies the machining-control-information generator 119 of machining order information indicating the specified machining order and path information indicating the set retraction path and the set approach path. In addition, the machining-order specifier 118 notifies the specified-information notifier 126 of the machining order information indicating the specified machining order.

The machining-control-information generator 119 acquires, from among the partial machining method information stored in the machining-method storage 134, partial machining method information corresponding to the machining method identification information notified from the feature specifier 115. Then, based on the acquired partial machining method information and the feature information notified from the feature specifier 115, the machining-control-information generator 119 selects, from among preset machining conditions including the type of a tool to be used and a movement path (machining path) of the tool, a machining condition corresponding to the feature information. Specifically, the machining-control-information generator 119 refers to the machining condition information stored in the machining-condition storage 137, and selects, based on partial machining method information and the feature information, machining condition information having no interference in machining of the machining target portion indicated by each piece of the feature information. The machining-control-information generator 119 generates machining control information for machining all the machining target portions corresponding to all pieces of the feature information, based on the selected machining condition information, the machining order information and the path information notified from the machining-order specifier 118, the feature information, and the partial machining method information. Then, the machining-control-information generator 119 notifies the simulation determiner 120 and the machining-control-information transmitter 121 of the generated machining control information.

The simulation determiner 120 determines, based on the machining control information notified from the machining-control-information generator 119, whether there is interference in machining of the machining target portion indicated by each piece of the feature information by performing machining simulation. When determining that there is interference in machining of the machining target portion as a result of the machining simulation, the simulation determiner 120 notifies the model updater 123 of interference occurrence notification information. The machining-control-information transmitter 121 transmits the machining control information generated by the machining-control-information generator 119 to the terminal device 2 based on the terminal identification information notified from the product-information acquirer 111.

When acquiring modification instruction information from the terminal device 3 of the administrator, the modification-instruction acquirer 122 extracts, from the acquired modification instruction information, the partial machining method information, the feature information, and the machining order information, and notifies the model updater 123 of the extracted partial machining method information, the extracted feature information, and the extracted machining order information.

When notified of the partial machining method information, the feature information, and the machining order information from the modification-instruction acquirer 122, the model updater 123 updates the machining-method specifying model, the feature specifying model, and the machining-order specifying model, using the notified partial machining method information, the notified feature information, and the notified machining order information, respectively. Here, the model updater 123 updates the machining-method specifying model, using a Q-value vector in which, for example, the Q-value of the machining method indicated by the partial machining method information notified from the modification-instruction acquirer 122 is set to a value larger than 0 and the Q-values of the other machining methods are set to 0 as teacher data. In addition, the model updater 123 updates the feature specifying model, using a Q-value vector in which, for example, the Q-value of the feature indicated by the feature information notified from the modification-instruction acquirer 122 is set to a value larger than 0 and the Q-values of the other features are set to 0 as teacher data. Furthermore, the model updater 123 updates the machining-order specifying model, using a Q-value vector in which, for example, the Q-value of the machining order indicated by the machining order information notified from the modification-instruction acquirer 122 is set to a value larger than 0 and the Q-values of the other machining orders are set to 0 as teacher data.

In addition, when acquiring the interference occurrence notification information from the simulation determiner 120, the model updater 123 selects new feature information and new machining order information different from the feature information and the machining order information specified using the feature specifying model and the machining-order specifying model, and updates the feature specifying model and the machining-order specifying model separately in the same manner as described above, using the selected feature information and the selected machining order information, respectively. When notified of the feature information and the machining order information from the load determiner 125, the model updater 123 selects new feature information and new machining order information different from the notified feature information and the notified machining order information, and updates the feature specifying model and the machining-order specifying model separately in the same manner as described above, using the selected feature information and the selected machining order information, respectively.

The load-information acquirer 124 acquires load information transmitted from the machine tool 4 and indicating a load applied to the tool when the machining target portion corresponding to each feature is machined, and notifies the load determiner 125 of the acquired load information. The load information includes load measurement information obtained by measuring the load applied to the tool, feature information corresponding to the machining target portion of the machine tool 4, and machining order information indicating the machining order when a machining target portion is machined. The load determiner 125 determines whether the load measurement value indicated by the load measurement information included in the load information notified from the load-information acquirer 124 exceeds a preset reference load. When determining that the load measurement value exceeds the reference load, the load determiner 125 notifies the model updater 123 of the feature information and the machining order information included in the load information.

The specified-information notifier 126 acquires the partial machining method information notified from the machining-method specifier 114, the feature information notified from the feature specifier 115, and the machining order information notified from the machining-order specifier 118. Then, the specified-information notifier 126 transmits the acquired partial machining method information, feature information, and machining order information to the terminal device 3 of the administrator.

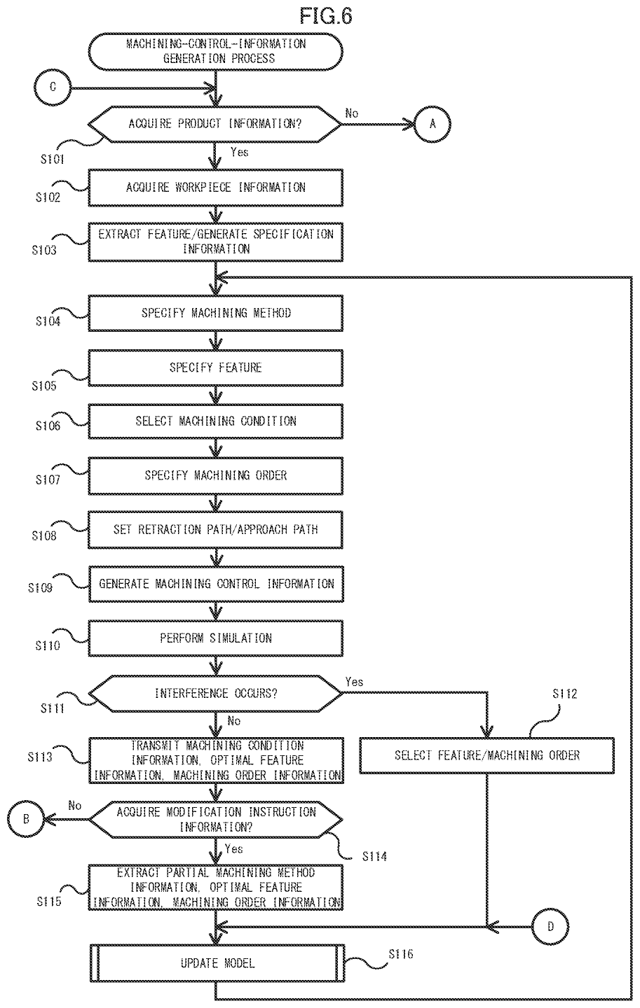

Next, a machining-control-information generation process performed by the machining-control-information generation device 1 according to the present embodiment will be described with reference to FIGS. 6 to 8. Note that this machining-control-information generation process is started when, for example, the machining-control-information generation device 1 is powered on and then an application for performing the machining-control information generation process is activated. First, as illustrated in FIG. 6, the product-information acquirer 111 determines whether the product information transmitted from the terminal device 2 has been acquired (step S101). Here, when the product-information acquirer 111 determines that the product information has not been acquired (step S101: No), a process in step S117 described later is performed.

On the other hand, it is assumed that the product-information acquirer 111 determines that the product information has been acquired (step S101: Yes). In this case, based on the product information, the workpiece-information acquirer 113 acquires workpiece information about a workpiece having the same material as the material of the product and having a shape and dimensions including the product from among the workpiece information stored in the workpiece-information storage 131 (step S102). Next, the feature extractor 112 refers to the basic feature information stored in the basic-feature storage 132, and searches for a portion matching the basic feature from among product shapes indicated by the product information, thereby extracting the feature included in the product. Then, the feature extractor 112 generates specification information corresponding to each feature from the feature information indicating each extracted feature, the product information notified from the product-information acquirer 111, and the workpiece information notified from the workpiece-information acquirer 113 (step S103). Here, the feature extractor 112 causes the extracted-feature storage 133 to store the feature information indicating the extracted feature.

Then, the machining-method specifier 114 specifies, from each piece of the feature information and the specification information stored in the extracted-feature storage 133, a machining method corresponding to each feature, using the above machining-method specifying model (step S104).

Thereafter, the feature specifier 115 specifies, from each piece of the feature information stored in the extracted-feature storage 133 and the machining method identification information notified from the machining-method specifier 114, an optimal feature to be used to machine the product, using the above feature specifying model (step S105).

Next, the machining-control-information generator 119 acquires partial machining method information corresponding to the machining method identification information specified by the machining-method specifier 114, and selects a machining condition based on the acquired partial machining method information and the feature information specified by the feature specifier 115 (step S106).

Then, the machining-order specifier 118 specifies, from the feature information and the partial machining method information, a machining order when all of machining target portions corresponding to each piece of the feature information, using the above machining-order specifying model (step S107).

Thereafter, when a machining target portion corresponding to each feature is machined according to the specified machining order, the machining-order specifier 118 sets a retraction path and an approach path of the tool from retraction from the machining target portion machined earlier to arrival at the machining target portion to be machined next (step S108).

Then, the machining-control-information generator 119 generates machining control information for machining all of the machining target portions corresponding to all pieces of the feature information, based on the machining order information, the path information, the machining condition information, the feature information, and the partial machining method information (step S109). Subsequently, the simulation determiner 120 performs machining simulation of the product based on the machining control information generated by the machining-control-information generator 119 (step S110).

Thereafter, the simulation determiner 120 determines whether interference has occurred in the machining of the machining target portion indicated by each piece of the feature information as a result of the machining simulation (step S111). Here, when the simulation determiner 120 determines that interference has occurred (step S111: Yes), the model updater 123 selects new feature information and new machining order information different from the feature information and the machining order information specified using the feature specifying model and the machining-order specifying model (step S112). Next, a model update process described later is performed to update the feature specifying model and the machining-order specifying model (step S116).

On the other hand, when the simulation determiner 120 determines that no interference has occurred (step S111: No), the specified-information notifier 126 acquires the partial machining method information, the feature information, and the machining order information, and transmits them to the terminal device 3 of the administrator (step S113). Subsequently, the modification-instruction acquirer 122 determines whether modification instruction information has been acquired from the terminal device 3 (step S114). Here, when determining that the modification instruction information has been acquired from the terminal device 3 (step S114: Yes), the modification-instruction acquirer 122 extracts, from the acquired modification instruction information, the partial machining method information, the feature information, and the machining order information (step S115). Thereafter, the model updater 123 performs the model update process for updating the machining-method specifying model, the feature specifying model, and the machining-order specifying model (step S116).

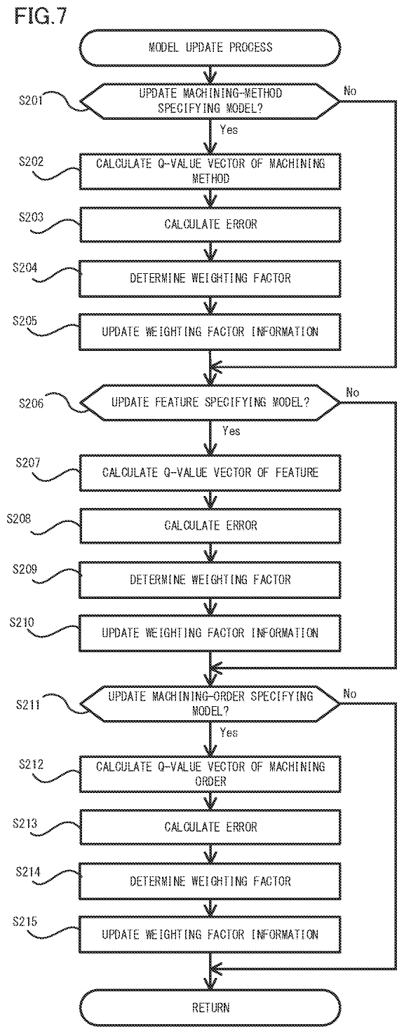

Here, the model update process performed by the machining-control-information generation device 1 according to the present embodiment will be described in detail with reference to FIG. 7. First, the model updater 123 determines whether to update the machining-method specifying model (step S201). When determining that the machining-method specifying model is not an update target (step S201: No), the model updater 123 performs a process in step S206 described later. On the other hand, when the model updater 123 determines that the machining-method specifying model is an update target (step S201: Yes), the model updater 123 calculates, from the feature information and the specification information stored in the extracted-feature storage 133, a Q-value vector having a Q-value corresponding to each of the plurality of types of preset machining methods as an element, using the machining-method specifying model (step S202). Next, the model updater 123 generates a Q-value vector in which the Q-value of the machining method indicated by the partial machining method information notified to the model updater 123 is set to a value larger than 0 and the Q-values of the other machining methods are set to 0, and calculates an error between the Q-value vector calculated in step S202 and the generated Q-value vector (step S203). Here, the model updater 123 calculates, for example, the norms of the two Q-factor vectors. Subsequently, the model updater 123 newly determines, based on the calculated error, a weighting factor of the neural network constituting the machining-method specifying model by backpropagation (step S204). Thereafter, the model updater 123 updates the weighting factor information stored in the machining-method specifying model storage 135 with weighting factor information indicating the determined weighting factor (step S205).

Next, the model updater 123 determines whether to update the feature specifying model (step S206). When determining that the feature specifying model is not an update target (step S206: No), the model updater 123 performs a process in step S211 described later. On the other hand, when the model updater 123 determines that the feature specifying model is an update target (step S206: Yes), the model updater 123 calculates, from the feature information and the specification information stored in the extracted-feature storage 133 and the machining method identification information specified by the machining-method specifier 114, a Q-value vector having a Q-value corresponding to each of a plurality of features as an element, using the above feature specifying model (step S207). Subsequently, the model updater 123 generates a Q-value vector in which the Q-value of the feature corresponding to the feature information notified to the model updater 123 is set to a value larger than 0 and the Q-values of the other features are set to 0, and calculates an error between the Q-value vector calculated in step S207 and the generated Q-value vector (step S208). Thereafter, the model updater 123 newly determines, based on the calculated error, a weighting factor of the neural network constituting the feature specifying model by backpropagation (step S209). Next, the model updater 123 updates the weighting factor information stored in the feature-specifying-model storage 136 with weighting factor information indicating the determined weighting factor (step S210).

Subsequently, the model updater 123 determines whether to update the machining-order specifying model (step S211). When determining that the machining-order specifying model is not an update target (step S211: No), the model updater 123 directly performs the process in step S104 in FIG. 6. On the other hand, as illustrated in FIG. 7, when the model updater 123 determines that the machining-order specifying model is an update target (step S211: Yes), the model updater 123 calculates a Q value corresponding to each of the plurality of types of preset machining orders from the feature information and the partial machining method information, using the above machining-order specifying model (step S212). Thereafter, the model updater 123 generates a Q-value vector in which the Q-value of the machining order indicated by the machining order information notified to the model updater 123 is set to a value larger than 0 and the Q-values of the other machining orders are set to 0, and calculates an error between the Q-value vector calculated in step S212 and the generated Q-value vector (step S213). Next, the model updater 123 newly determines, based on the calculated error, a weighting factor of the neural network constituting the machining-order specifying model by backpropagation (step S214). Subsequently, the model updater 123 updates the weighting factor information stored in the machining-order specifying model storage 138 with weighting factor information indicating the determined weighting factor (step S215). Returning to FIG. 6, thereafter, the process in step S104 is performed again.

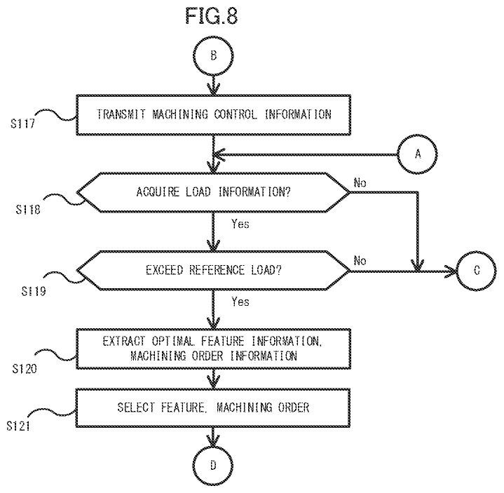

In addition, it is assumed that the modification-instruction acquirer 122 determines in step S114 that the modification instruction information has not been acquired from the terminal device 3 (step S114: No). In this case, as illustrated in FIG. 8, the machining-control-information transmitter 121 transmits the machining control information generated by the machining-control-information generator 119 to the terminal device 2 that is the transmission source of the product information acquired by the product-information acquirer 111 (step S117).

Subsequently, the load-information acquirer 124 determines whether the bad information transmitted from the machine tool 4 and indicating the bad applied to the tool when the machining target portion corresponding to each optimal feature is machined has been acquired (step S118). Here, when the load-information acquirer 124 determines that the load information has not been acquired (step S118: No), the process in step S101 is performed again. On the other hand, when the load-information acquirer 124 determines that the load information has been acquired (step S118: Yes), the load determiner 125 determines whether the load measurement value indicated by the load measurement information included in the load information exceeds a preset reference load (step S119). Here, when the load determiner 125 determines that the load measurement value is equal to or less than the reference load (step S119: No), the process in step S101 is performed again.

On the other hand, when the load determiner 125 determines that the load measurement value exceeds the reference load (step S119: Yes), the feature information and the machining order information included in the load information are extracted (step S120). Thereafter, the model updater 123 selects new feature information and new machining order information different from the feature information and the machining order information extracted from the load information (step S121). Next, a model update process described later is performed to update the feature specifying model and the machining-order specifying model (step S116).

As described above, in the machining-control-information generation device 1 according to the present embodiment, the feature specifier 115 specifies, from the feature information and the partial machining method information indicating the machining method specified by the machining-method specifier 114, an optimal feature, using the feature specifying model for specifying a feature optimal for machining the product. As a result, even if a plurality of types of features for one machining target portion is extracted by the feature extractor 112, it is possible for the feature specifier 115 to narrow down the features to be used to generate machining control information only to the optimal feature. Accordingly, it is possible to reduce the number of the features to be used to generate the machining control information, and thus to shorten the time for generating the machining control information from product information.

The embodiment of the present disclosure has been described above, but the present disclosure is not limited to the embodiment described above. For example, in the embodiment, a corrector that corrects the machining control information depending on the environment in which the machine tool 4 is installed may be provided. Specifically, the machining-control-information generation device may include, for example, an environmental parameter correlation information storage (not illustrated) that stores information indicating a correlation between a parameter of the environment (temperature, humidity, and the like) in which the machine tool 4 is installed, and a cutting speed, a polishing speed, or the like when a workpiece is cut, polished, or the like with a tool. Then, the corrector may acquire environmental parameter information transmitted from the machine tool 4, refer to the information stored in the environmental parameter correlation information storage to correct parameter information, such as the cutting speed and the polishing speed included in the machining control information, to parameter information indicating a parameter corresponding to the environmental parameter indicated by the acquired environmental parameter information.

In the embodiment, the example in which the forward propagation neural network is employed as the machining-method specifying model, the feature specifying model, and the machining-order specifying model has been described. However, the present disclosure is not limited thereto, and a convolutional neural network, a recurrent neural network, a Boltzmann machine, or the like may be employed. Alternatively, a support vector machine, a decision tree, and other models obtained by machine learning may be employed as the machining-method specifying model, the feature specifying model, and the machining-order specifying model.

In addition, various functions of the machining-control-information generation device 1 according to the present disclosure can be implemented using an ordinary computer system without using a dedicated system. For example, the machining-control-information generation device 1 that performs the above processes may be configured by storing a program for executing the above operation in a non-transitory recording medium, such as a compact disc read only memory (CD-ROM), readable by a computer system, distributing the program to a computer connected to a network, and installing the program in the computer system.

In addition, a method of providing the program to the computer is arbitrary. For example, the program may be uploaded to a bulletin board system (BBS) on a communication line and distributed to the computer via the communication line. Then, the computer starts and executes the program in the same manner as other applications under the control of an operating system (OS). As a result, the computer functions as the machining-control-information generation device 1 that performs the above processes.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### INDUSTRIAL APPLICABILITY

The present disclosure is suitable as a device that provides machining control information for a machine tool that cuts out a product from a workpiece from drawing information of the product.

### REFERENCE SIGNS LIST

1 Machining-control-information generation device
2, 3 Terminal device
4 Machine tool

### 101 CPU

102 Main storage
103 Auxiliary storage

### 106 Communicator

### 109 Bus

111 Product-information acquirer
112 Feature extractor
113 Workpiece-information acquirer
114 Machining-method specifier
115 Feature specifier
118 Machining-order specifier
119 Machining-control-information generator
120 Simulation determiner
121 Machining-control-information transmitter
122 Modification-instruction acquirer
123 Model updater
124 Load-information acquirer
125 Load determiner
126 Specified-information notifier
131 Workpiece-information storage
132 Basic-feature storage
133 Extracted-feature storage
134 Machining-method storage
135 Machining-method specifying model storage
136 Feature-specifying-model storage
137 Machining-condition storage
138 Machining-order specifying model storage
L10 Input layer
L20 Hidden layer
L30 Output layer

### NW Network

1. A machining-control-information generation device that generates machining control information for a machine tool to cut out a product by the machine tool from a workpiece, the machining-control-information generation device comprising:
a product-information acquirer that acquires product information indicating a finished shape and finished dimensions of the product;
a workpiece-information acquirer that acquires workpiece information indicating a shape, dimensions, and a material of the workpiece;
a feature extractor that extracts a feature indicating a shape feature of the product based on the product information;
a machining-method specifier that specifies, from feature information indicating the feature, a machining method, using a machining-method specifying model for specifying the machining method of cutting corresponding to each piece of the feature information;
a feature specifier that specifies, from the feature information and partial machining method information indicating the machining method specified by the machining-method specifier, an optimal feature, using a feature specifying model for specifying a feature optimal for machining the product;
a machining-order specifier that specifies, from optimal feature information indicating the optimal feature and the partial machining method information, a machining order when all of machining target portions corresponding to the optimal feature information are machined, using a machining-order specifying model for specifying the machining order when all of the machining target portions corresponding to the optimal feature information are machined; and
a machining-control-information generator that selects, from among preset machining conditions including a type of a tool to be used and a machining path of the tool, a machining condition corresponding to the machining method and the optimal feature information based on the partial machining method information and the optimal feature information indicating the optimal feature, and generates the machining control information based on machining order information indicating the machining order, machining condition information indicating the machining condition, the optimal feature information, and the partial machining method information.

2. The machining-control-information generation device according to claim 1, further comprising:
a modification-instruction acquirer that acquires modification instruction information for modifying at least one of the machining method specified by the machining-method specifier, the optimal feature specified by the feature specifier, and the machining order specified by the machining-order specifier; and
a model updater that updates at least one of the machining-method specifying model, the feature specifying model, and the machining-order specifying model based on at least one of partial machining method information indicating a modified machining method corresponding to the modification instruction information and optimal feature information indicating a modified optimal feature.

3. The machining-control-information generation device according to claim 2, further comprising:
a load determiner that determines whether a load applied to the machine tool when the machine tool is controlled using the machining control information generated by the machining-control-information generator exceeds a preset reference load, wherein
the model updater updates, when the load determiner determines that the load exceeds the reference load, at least one of the feature specifying model and the machining-order specifying model, using optimal feature information and partial machining method information different from the optimal feature information and the partial machining method information that have been used to generate the machining control information from the feature information.

4. The machining-control-information generation device according to claim 1, further comprising:
a machining-method storage that stores a plurality of pieces of partial machining method information indicating a plurality of respective types of machining methods each in association with machining method identification information, wherein
the machining-method specifier selects, from among the plurality of pieces of partial machining method information stored in the machining-method storage, partial machining method information corresponding to machining method identification information specified by the machining-method specifying model.

5. The machining-control-information generation device according to claim 1, further comprising:
a workpiece-information storage that stores a plurality of pieces of workpiece information each in association with at least one type of product information, wherein
the workpiece-information acquirer acquires, from among the plurality of pieces of workpiece information stored in the workpiece-information storage, workpiece information associated with the product information acquired by the product-information acquirer.

6. The machining-control-information generation device according to claim 1, further comprising:
a corrector that corrects the machining control information depending on an environment in which the machine tool is installed.

7. A machining-control-information generation method for generating machining control information for a machine tool to cut out a product by the machine tool from a workpiece, the machining-control-information generation method comprising the steps of:
acquiring product information indicating a finished shape and finished dimensions of the product;
acquiring workpiece information indicating a shape, dimensions, and a material of the workpiece;
extracting a feature indicating a shape feature of the product based on the product information;
specifying, from feature information indicating the feature, a machining method, using a machining-method specifying model for specifying the machining method of cutting corresponding to each piece of the feature information;
specifying, from the feature information and partial machining method information indicating the specified machining method, an optimal feature, using a feature specifying model for specifying a feature optimal for machining the product;
specifying, from optimal feature information indicating the optimal feature and the partial machining method information, a machining order when all of machining target portions corresponding to the optimal feature information are machined, using a machining-order specifying model for specifying the machining order when all of the machining target portions corresponding to the optimal feature information are machined;
selecting, from among preset machining conditions including a type of a tool to be used and a machining path of the tool, a machining condition corresponding to the machining method and the optimal feature information based on the partial machining method information and the optimal feature information indicating the optimal feature; and
generating the machining control information based on machining order information indicating the machining order, machining condition information indicating the machining condition, the optimal feature information, and the partial machining method information.

8. A non-transitory computer-readable recording medium storing a program, the program causing a computer to function as:
a product-information acquirer that acquires product information indicating a finished shape and finished dimensions of a product;
a workpiece-information acquirer that acquires workpiece information indicating a shape, dimensions, and a material of a workpiece;
a feature extractor that extracts a feature indicating a shape feature of the product based on the product information;
a machining-method specifier that specifies, from feature information indicating the feature, a machining method, using a machining-method specifying model for specifying the machining method of cutting corresponding to each piece of the feature information;
a feature specifier that specifies, from the feature information and partial machining method information indicating the machining method specified by the machining-method specifier, an optimal feature, using a feature specifying model for specifying a feature optimal for machining the product;
a machining-order specifier that specifies, from optimal feature information indicating the optimal feature and the partial machining method information, a machining order when all of machining target portions corresponding to the optimal feature information are machined, using a machining-order specifying model for specifying the machining order when all of the machining target portions corresponding to the optimal feature information are machined; and
a machining-control-information generator that selects, from among preset machining conditions including a type of a tool to be used and a machining path of the tool, a machining condition corresponding to the machining method and the optimal feature information based on the partial machining method information and the optimal feature information indicating the optimal feature, and generates machining control information for a machine tool to cut out the product by the machine tool from the workpiece based on machining order information indicating the machining order, machining condition information indicating the machining condition, the optimal feature information, and the partial machining method information.

9. The machining-control-information generation device according to claim 2, further comprising:
a machining-method storage that stores a plurality of pieces of partial machining method information indicating a plurality of respective types of machining methods each in association with machining method identification information, wherein
the machining-method specifier selects, from among the plurality of pieces of partial machining method information stored in the machining-method storage, partial machining method information corresponding to machining method identification information specified by the machining-method specifying model.

10. The machining-control-information generation device according to claim 3, further comprising:
a machining-method storage that stores a plurality of pieces of partial machining method information indicating a plurality of respective types of machining methods each in association with machining method identification information, wherein
the machining-method specifier selects, from among the plurality of pieces of partial machining method information stored in the machining-method storage, partial machining method information corresponding to machining method identification information specified by the machining-method specifying model.

11. The machining-control-information generation device according to claim 2, further comprising:
a workpiece-information storage that stores a plurality of pieces of workpiece information each in association with at least one type of product information, wherein
the workpiece-information acquirer acquires, from among the plurality of pieces of workpiece information stored in the workpiece-information storage, workpiece information associated with the product information acquired by the product-information acquirer.

12. The machining-control-information generation device according to claim 3, further comprising:
a workpiece-information storage that stores a plurality of pieces of workpiece information each in association with at least one type of product information, wherein
the workpiece-information acquirer acquires, from among the plurality of pieces of workpiece information stored in the workpiece-information storage, workpiece information associated with the product information acquired by the product-information acquirer.

13. The machining-control-information generation device according to claim 4, further comprising:
a workpiece-information storage that stores a plurality of pieces of workpiece information each in association with at least one type of product information, wherein
the workpiece-information acquirer acquires, from among the plurality of pieces of workpiece information stored in the workpiece-information storage, workpiece information associated with the product information acquired by the product-information acquirer.

14. The machining-control-information generation device according to claim 2, further comprising:
a corrector that corrects the machining control information depending on an environment in which the machine tool is installed.

15. The machining-control-information generation device according to claim 3, further comprising:
a corrector that corrects the machining control information depending on an environment in which the machine tool is installed.

16. The machining-control-information generation device according to claim 4, further comprising:
a corrector that corrects the machining control information depending on an environment in which the machine tool is installed.

17. The machining-control-information generation device according to claim 5, further comprising:
a corrector that corrects the machining control information depending on an environment in which the machine tool is installed.
